(19) United States
(12) Patent Application Publication
(10) Pub. No.: US 2023/0073349 A1
(43) Pub. Date: Mar. 9, 2023

(54) METHODS, SYSTEMS, AND DEVICES FOR BEVERAGE CONSUMPTION AND INVENTORY CONTROL AND TRACKING

(71) Applicant: BarMinder, Inc., Dover, DE (US)

(72) Inventors: Vince Anido, Carrollton, GA (US); Justin Park, Carrollton, GA (US)

(21) Appl. No.: 17/940,033

(22) Filed: Sep. 8, 2022

Related U.S. Application Data
(60) Provisional application No. 63/241,703, filed on Sep. 8, 2021.

(51) Int. Cl. G06Q 10/08

(52) U.S. Cl. CPC G06Q 10/087

(57) ABSTRACT

In one aspect, the present disclosure provides systems and methods for automatic detection and/or assignment of liquid pouring devices used in connection with inventory tracking. A system and associated method may comprise: affixing an identifying device, to a liquid dispensing container, the identifying device being associated with the liquid dispensing container; attaching a liquid pouring device to an opening of the liquid dispensing container; identifying the liquid dispensing container responsive to the liquid pouring device being within a predetermined proximity to the identifying device; and associating data collected from the liquid pouring device with the liquid dispensing container.

### RELATED APPLICATION

Under provisions of 35 U.S.C. § 119(e), the Applicant claims benefit of U.S. Provisional Application No. 63/241,703 filed on Sep. 8, 2021, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates methods, devices, and systems for tracking container inventory or contents, specifically for tracking the amount of liquid being poured or dispensed.

### BACKGROUND

In the dispensing of liquids, particularly alcoholic beverages, it is customary to use pouring spouts mounted on the tops of bottles to facilitate the dispensing with minimum spillage. In general, these pouring spouts are free flow pouring devices (i.e., the liquid continues to flow from the bottle so long as the bottle remains tilted. Customarily, the liquid is dispensed into a measuring vessel of fixed volume, as for example: ½ oz, ⅓ oz, 1 oz, 1½ oz, etc. and, when the desired volume is reached in the measuring vessel, the bottle is tilted to its upright non-pouring position. The contents of the measuring vessel, typically, is then emptied into a serving glass thereafter, or the like.

Consequently, a manager of a bar may employ different pour spouts that allow discrete amounts of liquid to be dispensed each time the bottle is tilted to its pouring position in order to control and more accurately dispense the liquids from said bottles.

Some of these different pour spouts even come equipped with an inventory tracking system that tracks the amount of each liquid poured by means of a computing device.

The procedure of manually tracking the amount of liquid poured from each bottle is sometimes a tedious and time-consuming process, whether done daily, weekly, or monthly. Currently, one must make a visual determination of the amount of liquid in each bottle, and accounting for the amount of bottles left in comparison with the amount of bottles originally in stock, thereby, at best, giving a rough estimation of the amount remaining. This manual tracking does not allow for precise measurement of inventory or further analytics such as volume dispensed during a certain temporal parameter.

However, even any pour spout having an inventory tracking mechanism requires manual entry of stock items and assignment of the spouts to designated bottles, as well as labeling of individual spouts, presenting similar issues with manual tracking. This leads to prolonged time for setup and the potential for error if, in the press of business, a bartender mistakenly places a pour spout assigned to a certain bottle onto a different bottle, thereby throwing off the inventory tracking for the two bottles.

Accordingly, there remains a need for an improved method and system of tracking inventory of dispensed liquids via pour spouts. This need and others are met by the various aspects of the present disclosure.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In various aspects, the present disclosure relates to systems and methods for automatic assignment, association, or registration of liquid pouring devices with liquid dispensing containers using identifying devices having unique product identifiers. In further aspects, the liquid pouring device may be configured to track inventory associated with the liquid dispensing container.

In further aspects, the present disclosure relates to a method for automatic detection of liquid dispensed from a liquid pouring device, the method comprising: affixing an identifying device, to a liquid dispensing container, the identifying device being associated with the liquid dispensing container; attaching a liquid pouring device to an opening of the liquid dispensing container; identifying the liquid dispensing container responsive to the liquid pouring device being within a predetermined proximity to the identifying device; and associating data collected from the liquid pouring device with the liquid dispensing container.

In another aspect, the present disclosure relates to an inventory tracking system, the system comprising: an identifying device comprising a product identifier, the identifying device configured to be connected to an opening of a liquid dispensing container; and a liquid pouring device comprising a unique pouring device identifier, the liquid pouring device configured to be secured to a top opening of a liquid dispensing container for dispensing liquid from therein; wherein upon being within a predetermined proximity of one another, the identifying device and liquid pouring device are configured to cooperate to trigger an association between the liquid dispensing container and the liquid pouring device.

In another aspect, the present disclosure relates to a method of automated inventory control of dispensed liquids, the method comprising: registering individual liquid pouring devices from a plurality of liquid pouring devices to individual liquid dispensing containers from a plurality of liquid dispensing containers, each liquid dispensing container comprising an identifying device, upon an individual liquid pouring device being within a predetermined proximity of a connected identifying device effective to trigger an association between the individual liquid pouring devices to the individual liquid dispensing container connected to said identifying device; receiving individual inventory data from each of the plurality of liquid pouring devices, each liquid pouring device of the plurality of liquid pouring devices being configured to receive and dispense a predetermined amount of liquid from each of the plurality of liquid dispensing containers, each of the plurality of liquid pouring devices being configured to transmit individual inventory data of the associated liquid dispensing container; and assembling inventory data for the plurality of liquid dispensing containers associated with the plurality of liquid pouring devices, the inventory data comprising a volumetric measurement of predicted liquid retained in each of the plurality of liquid dispensing containers.

In further aspects, the present disclosure also relates to methods for using the disclosed systems, devices and methods.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1A illustrates one embodiment of a cycle for which the invention goes through when in use;

FIG. 1B illustrates a liquid pouring device 100 affixed to a liquid dispensing container 175;

FIG. 2 illustrates the invention, displaying various perspectives and views that include, but are not limited to, cross sections, individual parts independently viewed and various angles of the embodiment;

FIG. 3A illustrates one example embodiment of sensing device useable with the device of FIG. 1;

FIG. 3B is a side view of the sensing device of FIG. 3A;

FIG. 4A illustrates an embodiment of a device consistent with embodiments of the present disclosure, having a cover on it;

FIG. 4B illustrates an embodiment of a device consistent with embodiments of the present disclosure, without a cover on;

FIG. 4C illustrates an embodiment of a device consistent with embodiments of the present disclosure, without a cover on it, mounted on a liquid dispensing container;

FIG. 5 illustrates an operating environment for providing a computing platform consistent with embodiments of the present disclosure;

FIG. 6 illustrates another operating environment for providing a marketplace consistent with embodiments of the present disclosure;

FIG. 7 is a flowchart of a method 1100 of automated inventory control of dispensed liquids consistent with embodiments of the present disclosure;

FIG. 8 is a flowchart of a method 1200 of automated inventory control of dispensed liquids consistent with embodiments of the present disclosure;

FIG. 9 illustrates a computing device 900 consistent with embodiments of the present disclosure;

FIG. 10 is a flowchart of a method 1300 of automated inventory control of dispensed liquids consistent with embodiments of the present disclosure;

FIG. 11 is a flowchart of a method 1000 of automated inventory control of dispensed liquids consistent with embodiments of the present disclosure; and

FIG. 12 illustrates a liquid pouring device 100.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subjected matter disclosed under the header.

The present disclosure includes many aspects and features. Moreover, while many aspects and features relate to, and are described in, the context of tracking the amount of liquid being poured from a pour spout, embodiments of the present disclosure are not limited to use only in this context.

### I. System Overview

This overview is provided to introduce a selection of concepts in a simplified form that are further described below. This overview is not intended to identify key features or essential features of the claimed subject matter. Nor is this overview intended to be used to limit the claimed subject matter's scope.

In one aspect, the disclosure provides a method and system for automatic assignment, association, or registration of inventory-tracking liquid pouring devices with liquid dispensing containers using identifying devices having unique product identifiers. In further aspects, the liquid pouring device may be configured to receive and dispense a predetermined amount of liquid from a liquid dispensing container, and each liquid pouring device is configured to transmit individual inventory data of the associated liquid dispensing container.

In another aspect, the present disclosure provides a method for automatic assignment or registration of the liquid pouring devices to a container or bottle. Such a method may comprise connecting an identifying device, comprising a unique product identifier, proximate to a top opening of a liquid dispensing container; securing a liquid pouring device, comprising a unique pouring device identifier, to the top opening of the liquid dispensing container; associating the liquid dispensing container and the liquid pouring device upon the identifying device and the liquid pouring device being within a predetermined proximity of one another; and receiving inventory data of the associated liquid dispensing container. The method may further comprise assigning a unique product identifier to the identifying device and receiving a notification of association between the liquid dispensing container and the liquid pouring device. In still further aspects, associating or registering comprises assigning associated identifying data to a liquid pouring device, the identifying data identifying a particular type of liquid dispensing container associated with the liquid pouring device.

In another aspect, the present disclosure provides an inventory tracking system capable of automatic assignment or registration of liquid pouring devices to a container or bottle. The system generally includes an identifying device comprising a unique product identifier, the identifying device configured to be connected proximate to a top opening of a liquid dispensing container; and a liquid pouring device comprising a unique pouring device identifier, the liquid pouring device configured to be secured to a top opening of a liquid dispensing container for dispensing liquid from therein. Upon being within a predetermined proximity of one another, the identifying device and liquid pouring device are configured to cooperate to trigger an association between the liquid dispensing container and the liquid pouring device. The system may further comprise a hub device configured to receive a notification of association between the liquid dispensing container and the liquid pouring device, and receive inventory data of the associated liquid dispensing container.

In various aspects, an identifying device comprising a unique product identifier, is configured to be connected or attached to a bottle, such as proximate to a top opening of a liquid dispensing container. The identifying device may comprise a transmitting element or device configured to transmit a unique product identifier, such as, for example, to the liquid pouring device upon being within a predetermined proximity of one another. In some aspects, the identifying device may be configured to provide the unique product identifier to the liquid pouring device using a readable medium and/or transmitting device. The readable medium may comprise a barcode, QR code, or other like means of representing data in a visual, machine-readable form. In further aspects, the transmitting device may comprise Near Field Communication (NFC), Radio Frequency Identification (RFID), Bluetooth, and/or other wireless technologies and protocols. The identifying device generally comprises or takes the form of a label, tag, sticker, or the like configured to be attached or printed on a surface proximate to and/or circumferentially around the top opening, spout or neck of a container or bottle.

In various aspects, a liquid pouring device may be configured to a liquid dispensing container such as, but not limited to, a bottle. The liquid pouring device may comprise a unique pouring device identifier, and the liquid dispensing container may comprise its own transmitting device or transceiver for communicating with the identifying device on a bottle and other device, such as a hub or server. The liquid pouring device may be configured to obtain the unique product identifier from the identifying device upon being within a predetermined proximity of one another, for example, the liquid pouring device may comprise a transceiver device and/or receiver configured to receive the unique product identifier from the identifying device upon being within a predetermined proximity of one another.

In some embodiments, the liquid pouring device may comprise a sensor stick with sensors configured to obtain or read the unique product identifier from the identifying device upon being within a predetermined proximity of one another. In other embodiments, the liquid pouring device may comprise a transceiver device configured to receive the unique product identifier from the identifying device upon being inserted into the neck of the liquid dispensing container. In still other embodiments, the liquid pouring device may comprise a sensor cavity with a sensor stick configured to obtain the unique product identifier from the identifying device upon being inserted into the neck of the liquid dispensing container. In yet other embodiments, the liquid pouring device may comprise a sensor cavity with a transceiver and/or receiver configured to receive the unique product identifier from the identifying device upon being inserted into the neck of the liquid dispensing container.

In further aspects, the unique product identifier may generally comprise identifying data related to the liquid dispensing container or identifying information related to the liquid dispensing container contents. In still further aspects, the unique product identifier may comprise identifying data or identifying information corresponding to the composition and/or quantity contents of the liquid dispensing container. In yet further aspects, the unique product identifier comprises product identifying data or product identifying information. In some aspects, the unique product identifier comprises identifying data or product identifying information corresponding to one or more of: a product universal product code (UPC), product stock keeping unit (SKU), product brand, product container size, product type, product content, product volume, product weight, product production date, product expiration date, product attribute, product property, or combination thereof.

In further aspects, the liquid pouring device being secured to the liquid dispensing container, the identifying devices may associate the liquid pouring device with the liquid dispensing container upon being a predetermined proximity. The association may be registered with a hub device configured to receive inventory data from the liquid dispensing container. In still further aspects, the predetermined proximity may comprise a predetermined geometry and/or predetermined orientation between the liquid pouring device and identifying device. In yet further aspects, the predetermined proximity may comprise a predetermined minimum time within the predetermined proximity. In some aspects, the predetermined orientation comprises a parallel orientation, for example, a parallel orientation where the identifying device is placed on a neck of the liquid dispensing container and the corresponding portion of the liquid pouring device is inserted into the neck of the container. In even further aspects, the identifying device may be disposed around a circumference of the top opening effective to align or substantially align the neck of the bottle, such as where the predetermined orientation of a field is down from the top opening.

In further aspects, the liquid pouring device may be configured to receive a liquid from the container and transfer the liquid through a chamber within the device. As the liquid is transferred through the liquid pouring device, a computing element and sensing component integrated within the device may be configured to track an amount of liquid dispensed through the device. A communications module may then communicate the data with the hub device.

Still consistent with embodiments of the present disclosure, the device may be configured to limit an amount of liquid dispensed through the device by way of a calibrated chamber which dispenses a specific amount each time the bottle inverts. In turn, the device may be configured to sense an amount of liquid poured through the device. The device may then communicate the sensor data to a computing element, either integrated within the device itself, and/or to a network computing element.

The computing element, having received the data from the device, may then calculate, for example, at least one of the following: an amount of liquid dispensed and an amount of liquid remaining in the bottle to which the device is attached. Accordingly, the device may be paired or registered with the platform, along with a specification of a liquid container type that the device is configured to. In this way, the system 600 may be configured to report a plurality of metrics associated with a plurality of liquid containers having a device consistent with embodiments of the present disclosure configured thereto.

Embodiments of the present disclosure may comprise methods, systems, and a computer readable medium comprising, but not limited to, at least one of the following:
A. A Liquid Dispensing Container 175 connected to an Identifying Device 151;
B. A Liquid Pouring Device 100;
C. A Hub Device 700; and

In some embodiments, the present disclosure may provide an additional set of modules for further facilitating the methods, systems, and a computer readable medium. The additional set of modules may comprise, but not be limited to:
D. A Marketplace Module 800.

Details with regards to each module is provided below. Although modules are disclosed with specific functionality, it should be understood that functionality may be shared between modules, with some functions split between modules, while other functions duplicated by the modules. Furthermore, the name of the module should not be construed as limiting upon the functionality of the module. Moreover, each component disclosed within each module can be considered independently without the context of the other components within the same module or different modules. Each component may contain language defined in other portions of this specifications. Each component disclosed for one module may be mixed with the functionality of another module. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of operations disclosed with reference to each module. For example, although methods may be described to be performed by a single computing device, it should be understood that, in some embodiments, different operations may be performed by different networked elements in operative communication with the computing device. For example, at least one computing device 900 may be employed in the performance of some or all of the stages disclosed with regard to the methods. Similarly, an apparatus may be employed in the performance of some or all of the stages of the methods. As such, the apparatus may comprise at least those architectural components as found in computing device 900. Additionally, the at least one computing device, apparatus, and/or platform may be employed in at least one of the following configurations:
a. at least one liquid pouring device,
b. the at least one liquid pouring device in operative communication with a hub,
c. the hub in operative communication with an external network and/or database,
d. the at least one liquid pouring device in operative communication with at least one other liquid pouring device, and
e. any combination thereof.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed without altering or deterring from the fundamental scope of the depicted methods and systems disclosed herein.

Consistent with embodiments of the present disclosure, a method may be performed by at least one of the modules disclosed herein. The method may be embodied as, for example, but not limited to, computer instructions, which when executed, perform the method. Method of the present invention may comprise one or more of the following stages:

A method for automatic detection of liquid dispensed from a liquid pouring device, the method comprising:

affixing an identifying device, to a liquid dispensing container, the identifying device being associated with the liquid dispensing container;

attaching a liquid pouring device to an opening of the liquid dispensing container;

identifying the liquid dispensing container responsive to the liquid pouring device being within a predetermined proximity to the identifying device; and

associating data collected from the liquid pouring device with the liquid dispensing container.

A method of automated inventory control of dispensed liquids, the method comprising:

automatically registering individual liquid pouring devices to be associated with individual liquid dispensing containers upon being within a predetermined proximity of one-another;

receiving individual inventory data from a plurality of liquid pouring device, each liquid pouring device of the plurality of liquid pouring devices being configured to receive and dispense a predetermined amount of liquid from a liquid dispensing container, and each of the plurality of liquid pouring devices configured to transmit individual inventory data of the associated liquid dispensing container; and

assembling inventory data for all liquid dispensing containers associated with a liquid pouring device, the inventory data including a volumetric measurement of predicted liquid retained in each liquid dispensing container

Although the aforementioned method has been described to be performed by a system 600, it should be understood that a computing device 900 may be used to perform the various stages of the method. Furthermore, in some embodiments, different operations may be performed by different networked elements in operative communication with computing device 900. For example, a plurality of computing devices may be employed in the performance of some or all of the stages in the aforementioned method. Moreover, a plurality of computing devices may be configured much like a single computing device 900. Similarly, an apparatus may be employed in the performance of some or all stages in the method. The apparatus may also be configured much like computing device 900.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

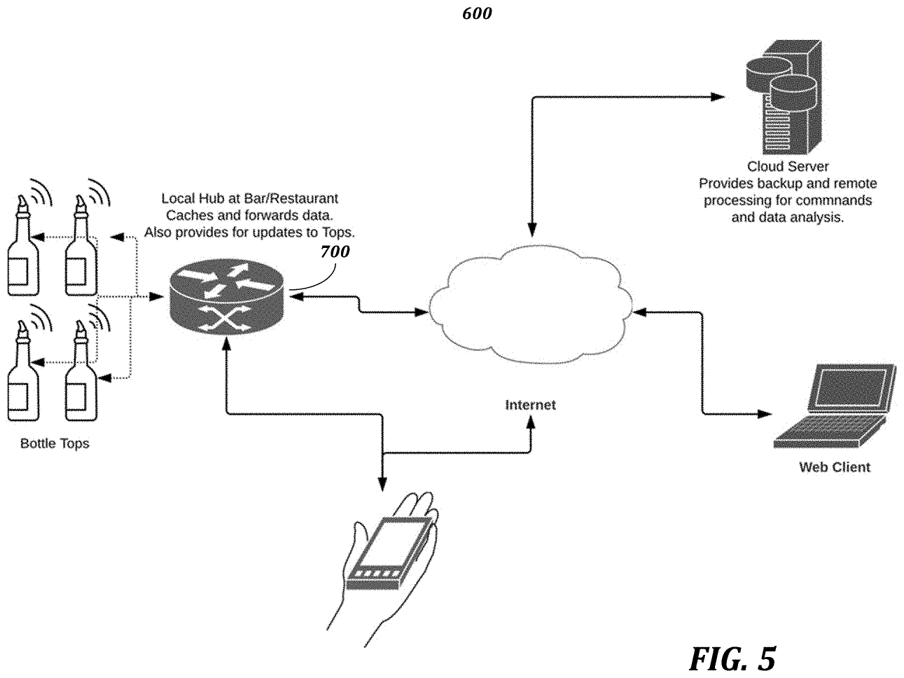

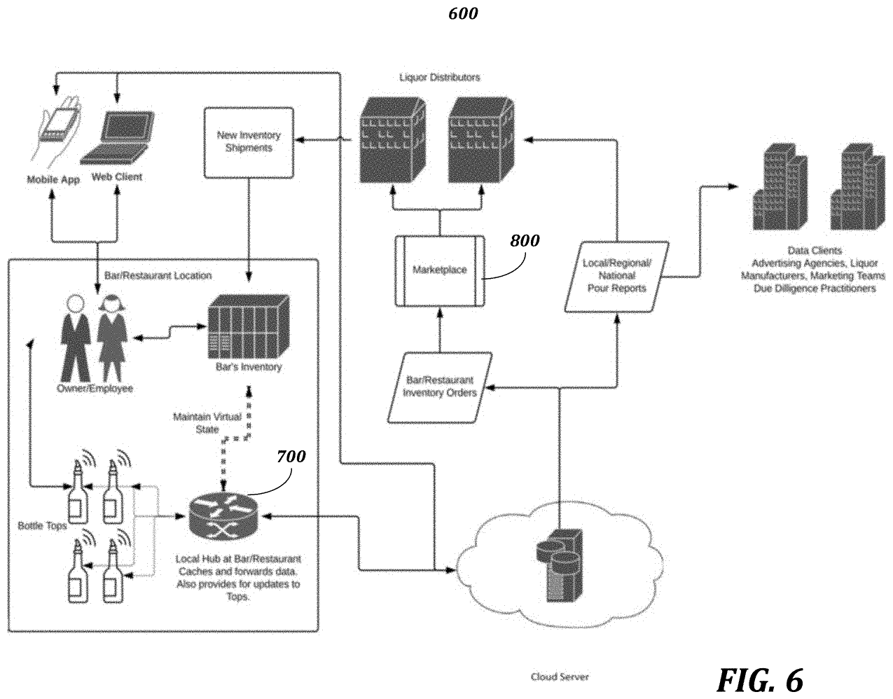

FIGS. 5, 6, and 9 illustrate possible operating environments through which at least a portion of the system 600 consistent with embodiments of the present disclosure may be provided. By way of non-limiting example, an inventory tracking system (and/or platform) 600 may be hosted on, for example, a cloud computing service. In some embodiments, at least a portion of the system 600 may be hosted on a computing device 900. A user may access platform 600 through a software application and/or hardware device. The software application may be embodied as, for example, but not be limited to, a website, a web application, a desktop application, and a mobile application compatible with the computing device 900. One possible embodiment of the software application and/or hardware device may be provided by the BarMinder™ suite of products and services provided by BarMinder, Inc.

FIGS. 5, 6, and 9 illustrate possible operating environments through which at least a portion of the system 600 consistent with embodiments of the present disclosure may be provided. By way of non-limiting example, the inventory tracking system 600 for providing the methods and systems for may be hosted in both a blockchain protocol (“on-chain”) and off of a blockchain protocol (“off-chain”). One possible embodiment of the platform may be provided by the BarMinder™ protocol provided by BarMinder, Inc. It should be understood that layers and stages performed by the layers may be either “on-chain” or “off-chain.” The present disclosure anticipates embodiments with variations as to which stages may be performed “on-chain” or “off-chain.”

It is noted that the term “connect(ing)” may be used interchangeably with at least the following terms:
a. secure(ing),
b. attach(ing),
c. releasably attach(ing),
d. couple(ing),
e. join(ing),
f. affix(ing), and
g. join(ing).

Accordingly, embodiments of the present disclosure provide a software and hardware platform comprised of a distributed set of computing elements, including, but not limited to:

A. Liquid Dispensing Container 175

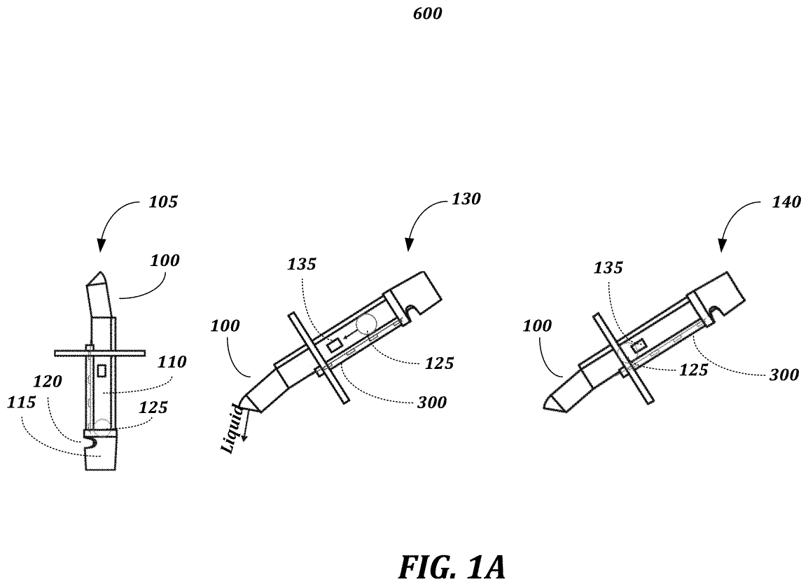

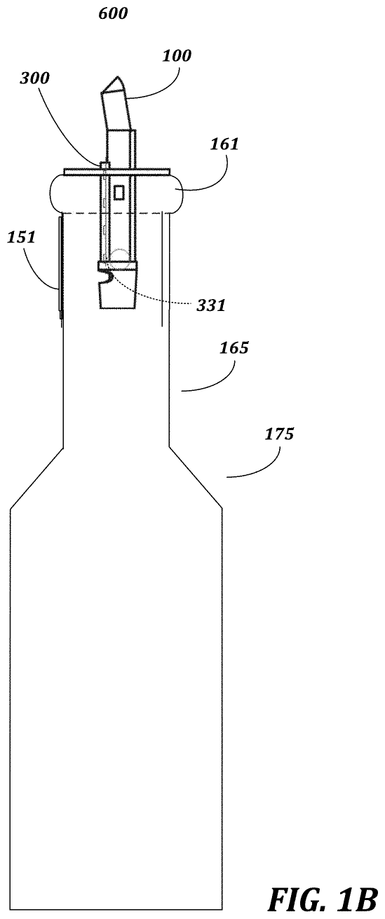

A liquid dispensing container 175 consistent with embodiments of the present disclosure may be provided, illustrated at least in FIG. 1B.

The liquid dispensing container may be embodied as, by way of nonlimiting example, a container, a reusable container, a bottle, a liquor bottle, and/or a wine bottle. In some embodiments, the liquid dispensing container may comprise a neck 165. In further embodiments, the liquid dispensing container may comprise a top opening 161. In some embodiments, the top opening may be located at one end of the neck 165.

In yet further embodiments the liquid dispensing container may comprise an identifying device 151. In some embodiments, the identifying device 151 may comprise a unique product identifier. In some embodiments, the unique product identifier may comprise information such as, for example, but not limited to: type of liquor in the liquid dispensing container, brand of liquor in the liquid dispensing container, volume of liquid in the liquid dispensing container, time period of the liquid dispensing container since being bottled and/or sealed, price of the liquid dispensing container, and price per ounce of the liquid dispensing container.

In further embodiments, the identifying device 151 may be configured to trigger an association of the liquid dispensing container 175 and the liquid pouring device 100, upon the identifying device 151 and a transceiver, receiver, and/or reader device being within a predetermined proximity of one another.

B. Liquid Pouring Device 100

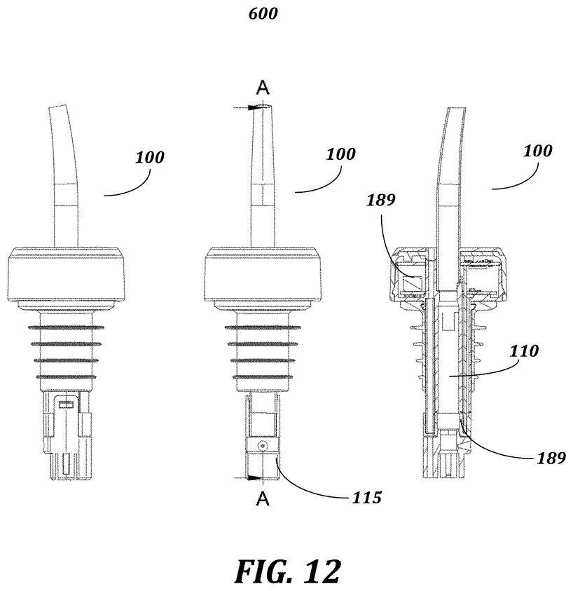

A liquid pouring device (and/or spout) 100 consistent with embodiments of the present disclosure may be provided, illustrated at least in FIGS. 1A, 1B, 2, and 12. The liquid pouring device 100 may be embodied as, by way of nonlimiting example, a liquid pourer, a liquor pourer, a vented pourer, a speed pourer, and a liquor spout.

In some embodiments, the liquid pouring device 100 may be configured to receive a liquid from the liquid dispensing container 175 and transfer the liquid through a chamber within the liquid pouring device 100. As the liquid is transferred through the liquid pouring device 100, a computing element and sensing component (i.e., at least one sensor and/or sensor stick) integrated within the liquid pouring device 100 may be configured to track an amount of liquid dispensed through the liquid pouring device. A communications module may then communicate data associated with the amount of liquid dispensed through the liquid pouring device with the hub device 700.

In further embodiments, the liquid pouring device 100 may be configured to limit an amount of liquid dispensed through the device by way of a calibrated chamber which dispenses a specific amount each time the bottle inverts. In turn, the liquid pouring device 100 may be configured to sense an amount of liquid poured through the device. The liquid pouring device 100 may then communicate the sensor data, via instructions over a wireless communication protocol, to a computing element and/or processor, either integrated within the liquid pouring device itself, and/or to a network computing element and/or the hub device 700.

In yet further embodiments, the liquid pouring device 100 may comprise a transceiver, receiver, and/or reader device 189. In some embodiments, the liquid pouring device 100 or transceiver, receiver, and/or reader device 189 may comprise a unique pouring device identifier.

In still further embodiments, the liquid pouring device 100 may comprise a top configured to seat onto the top opening of the liquid dispensing container. In even further embodiments, the liquid pouring device may comprise a cover. In some embodiments, the cover may be arranged on the top. In further embodiments, the cover may be sized to house circuitry, at least one sensing component, and/or at least one antenna. A device consistent with embodiments of the present disclosure may be, for example, a liquid pouring spout (referred to as a “device” throughout the present disclosure) that connects to a liquid container. In some embodiments, as with conventional liquid pouring spouts, the device may comprise an adjustably controllable measuring liquid pourer for dispensing liquid in a predetermined quantity.

FIG. 1A illustrates one possible embodiment of the liquid pouring spout (and/or device) 100, in three configurations. In a first configuration 105, spout 100 may be in an upright position, ready to receive liquid. In a second configuration 130, spout 100 may be receiving liquid through the chamber. In a third configuration 140, spout 100 may have completed the dispensing of liquid. The following disclosure will describe spout 100, as a device 100, through the various configurations.

Consistent with embodiments of the present disclosure, device 100 may comprise a calibrated chamber 110 which may be configured to limit the flow of liquid to a specific amount each time the bottle is positioned to dispense the liquid through the device. In some embodiments, chamber 110 may be adjusted to a desired volumetric flow rate of liquid. The adjustment of chamber 110 may be performed mechanically, through various components configured to affect the flow rate of liquid through the device. In some embodiments, a plurality of devices may come with a specific chamber caliber pre-set, with an inter-changeable cap 115 for each pour amount.

Still, in further embodiments, it is anticipated that, for example, a computer-controlled actuator may be configured to dynamically and programmatically adjust a property of device 100 (e.g., an opening 120 of cap 115) so as to affect the flow rate through device 100. In this way, for example, a remote operator of the device may be enabled, via a computing device and communications module, to control the limits of liquid flow through device 100. In turn, the specification of chamber calibration may be accounted for by a computing device associated with device 100. In this way, based on the particular calibration of the device 100 (e.g., byway of chamber 110 or cap 115), the sensor data may be analyzed to ascertain an amount of liquid poured through the device.

In some embodiments, device 100 may be configured obtain a unique product identifier from an identifying device 151 upon being within a predetermined proximity of one another, such as when inserted into a liquid container opening (e.g., at the top of a bottle). For example, the identifying device 151 may be a label or tag that is connected or otherwise attached to a neck or top opening, and device 100 may comprise a transceiver, receiver, and/or reader device configured to receive the unique product identifier from the identifying device 151 when the corresponding part of device 100 is inserted into the container and within a predetermined proximity and orientation of the identifying device 151. Identifying device 151 may take the form a label, tag, or sticker attached or printed on a surface proximate to and/or circumferentially around the top opening of the bottle.

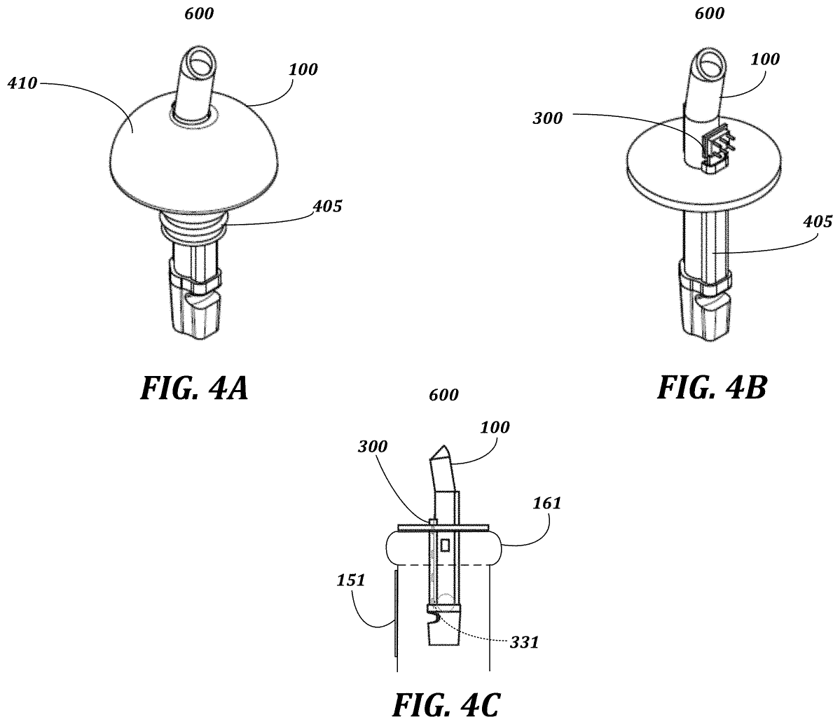

Referring still to FIG. 1, chamber 110 within upright configuration 105 may comprise a ball bearing 125 resting at the base of camber 110, adjacent to cap 115. Cap 115 may comprise a cut-out 120 for receiving a liquid into chamber 110 from a liquid container to which device 100 may be configured. In some embodiments, cap 115 may be configured so as to be inserted into a liquid container opening (e.g., at the top of a bottle) and receive the liquid from the container. In such embodiments, and as illustrated with reference to FIGS. 4A and 4B, a stopping and sealing means 405 may be provided to ensure a secure connection to a liquid container. The stopping and sealing means 405 may comprise, but not be limited to, for example, a silicon, rubber, elastomeric, silicone, polyurethane, plastic, or cork material. Still, within upright configuration 105, ball bearing 125 may rest at the base of the chamber, thereby sealing the liquid within the container connected to device 100.

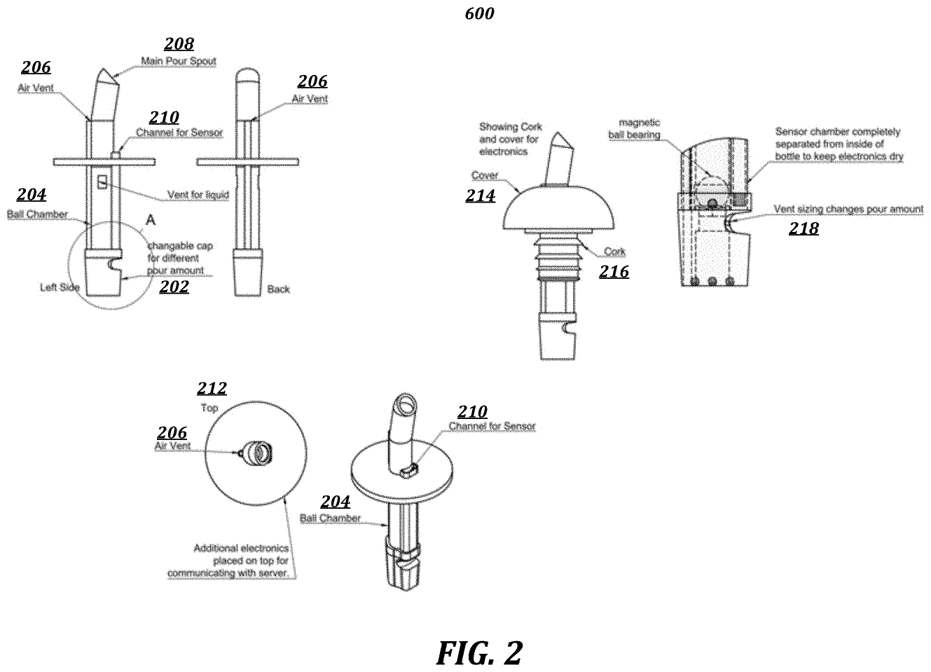

Referring back to FIG. 1A, pouring configuration 130, liquid may enter device 100 through opening 135, filling chamber 110. A vacuum effect may be created with opening 120, thereby causing ball bearing 125 to float on the liquid through chamber 110, as facilitated by an air vent cut-out 120 positioned within chamber 110. To understand the operation of device 100 during pouring configuration 130, we turn to FIGS. 2-4.

Still consistent with embodiments of the present disclosure, and as illustrated in FIG. 2, a hollow space (herein known as a “channel for sensor”) may be designed alongside chamber 110, spanning the length of chamber 110. The channels purpose may be, but is not limited to, to create a space for the sensor stick to be placed secure and flush alongside the ball chamber 110.

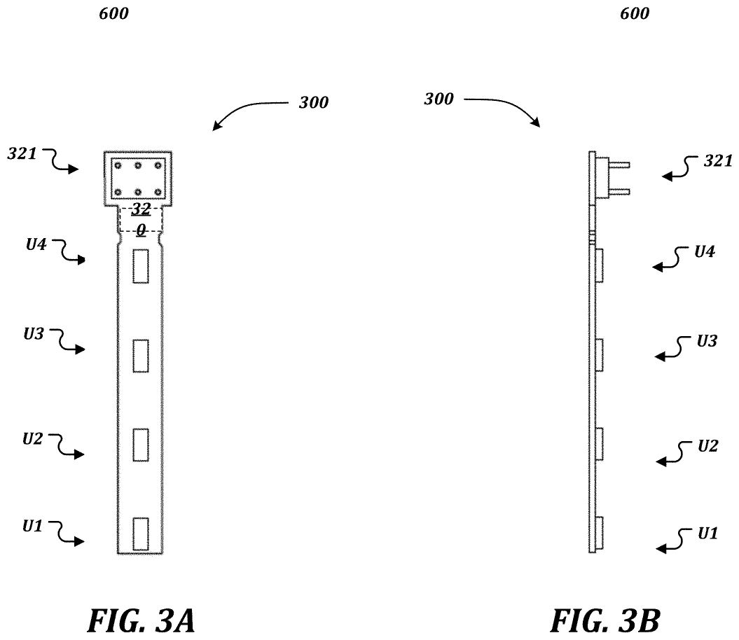

A magnetic sensing device comprising a magnetic sensor circuitry (hereinafter referred to as a “sensor stick”) may be placed inside the channel for sensor. FIGS. 3A-3B illustrates one example embodiment of sensing device 300, and FIGS. 4A-B illustrate how sensing device 300 may be inserted into the channel. Sensing device 300 may comprise two primary components: a circuit board of a predetermined width having at least one processor 320 thereon, the length of the circuit board being at least the span of the ball chamber 110; and a plurality of sensors U1, U2, U3, and U4. The sensing device 300 may also include a physical connector or interface 321, configured to communicate with an external processor (not illustrated) or other device. It is noted that processor 320 may be physically present on the sensing device 300, or may be a separate device (not illustrated). The circuit board may be a printed circuit board and may include printed circuitry and may be sized to be retained within the channel for sensor. There may be no limitation to a quantity of sensors used. In some embodiments, the quantity may range from one to four sensors, mounted on the circuit board and orientated, by way of non-limiting example, equidistant from each other (See FIG. 3, sensors U1-U4).

In further aspects, sensing device 300 may be further configured, such as with additional sensors, to read or otherwise obtain the unique product identifier from a identifying device label upon being within a predetermined proximity of it, such when inserted into a container.

Consistent with embodiments of the present disclosure, ball bearing 125 may have magnetic properties so as to interface with sensing device 300. The magnetic field sensors on the sensing device 300 may be used to determine the magnetic ball bearing's location. In some embodiments, sensing device 300 may determine the magnetic ball bearing's location using, for example, without limitation, the hall effect. The hall effect is the production of a voltage difference across an electrical conductor, transverse to an electric current in the conductor and to an applied magnetic field perpendicular to the current. By tracking location of ball bearing 125 as a function of the pour spout's position, the amount of liquid released may be tracked by a computing device in accordance to embodiments disclosed herein. Tracking may comprise, but not be limited to, for example, calculating the displacement of ball bearing 125 within chamber 110.

In some embodiments, the sensors may be coupled with additional components, use alternative measurements (e.g., magnetic flux, electrical flux, linear induction, and/or EM flux) to ascertain the ball bearing's location. For example, optomechanical systems and corresponding sensors may be used in conjunction with, or ingratiated with, the sensing device 300. In further embodiments, a magnetically operated mechanical switch may be used in conjunction with, or ingratiated with, the sensing device 300. In yet further embodiments, MEMS magnetic field sensors using Lorentz force may be used in conjunction with, or ingratiated with, the sensing device 300. Furthermore, although particularly described as using a magnetic field sensor or other sensor in the several preceding examples herein, capacitance sensing, limit-switch sensing, physical displacement sensing, and any other suitable form of sensing is also applicable. Accordingly, it should be understood by one of ordinary skill in the field of the present disclosure that a plurality of systems may be adapted to be in conjunction with, or integrated with, sensing device 300 to achieve the desired results.

Referring now to FIG. 4A and FIG. 4B, device 100 may comprise a cover 410 corresponding to the area and shape of the main pour spout and air vent 206, so as to fit flush with the main pour spout and prevent moisture from entering through cover 410. The material of cover 410 may be made from, but not limited to metal, plastic, or wood. Cover 410 may be used, but not limited to, for example, insulate the channel for sensor from outside elements such as, but not limited to, liquid, dirt, and grime.

Accordingly, referring back to FIG. 1A, device 100 may allow measured liquid pours specified by a user to be administered from a bottle in discrete portions. Device 100 may be attached to the opening of a bottle containing liquid. The starting orientation, in the initial configuration 105, may be such that a base of a liquid container (e.g., the bottle) is level with the ground, with the pour spout facing upwards, perpendicular with the ground, and ball bearing 125 is at the bottom of chamber 110.

Turing towards configuration 130, device 100 may then invert (i.e., Rotated 90°-180° from original orientation) such that ball bearing 125 begins travel down the path of the ball chamber 110. The liquid in ball chamber 110 may then be expelled by the force of gravity, and force ball bearing 125 down the chamber 110. The displacement of ball bearing 125 is detected by sensing device 300 and is used, in turn, to track an amount of liquid dispensed during the pour.

Now in configuration 140, ball bearing 125 may cease travel when it reaches “top” of the ball chamber 110, as ball bearing 125 may be configured to seal a pouring hole in device 100. In some embodiments, ball bearing 125 may also cover, at least in part, air-vent 135, further affecting the liquid flow rate. In scenarios of a partial pour, ball bearing 125 may not be completely forced to the “top” of chamber 110 (e.g., device 100 is not inverted long enough for ball bearing 125 to travel the length of chamber 110 is then reverted to its initial configuration 110. Nevertheless, sensing device 300 may still measure the total displacement of ball bearing 125 within chamber 110.

In some embodiments, the measured distance may be exported to a computing device (e.g., a hub). Having each pour spout assigned to a particular spirit, the measured distance may serve as input to an algorithm configured to calculate an amount of liquid dispensed from the bottle to which device 100 is affixed.

As described above, the device 100 may include a variety of features and mechanics configured to assist in tracking inventory. For example, with reference to FIG. 2, the device may include a bottom cap 202. The bottom cap 202 includes a first opening 218 to receive a liquid from a bottle and a second opening to measurably release the received liquid into ball chamber 204. Generally, increasing the size of the first opening 218 of the bottom cap 202 decreases the predetermined amount of the liquid. Similarly, decreasing the size of the first opening 218 of the bottom cap 202 increases the predetermined amount of liquid.

The ball chamber 204 is arranged on the bottom cap 202. The ball chamber 204 includes a bottom opening in fluid communication with the second opening of the bottom cap 202. The ball chamber 204 includes a cylindrical cavity arranged to retain the ball bearing and the predetermined amount of liquid. The cylindrical cavity is also in fluid communication with the bottom opening. Finally, the ball chamber 204 also includes a top opening in fluid communication with the cylindrical cavity so that liquid can be poured through to main pour spout 208.

Air vent 206 is arranged proximate the ball chamber 204. Air vent 206 is configured to receive air from an exterior of a liquid dispensing container and direct the received air to the interior of the liquid dispensing container.

The sensor cavity 210 is arranged proximate the ball chamber 204. The sensor cavity 210 is also termed a “channel for sensor” herein, and is an elongated channel configured to retain at least one sensor. Generally, the at least one sensor can be actuated by the ball bearing as described herein. Additionally, the sensor cavity 210 is sealed to prevent the liquid from entering the sensor cavity 210 and fouling the at least one sensor.

The device 100 may also include a top 212 configured to seat onto or about a neck or top opening of a liquid dispensing container, such as a liquor or wine bottle. The top 212 may be covered by cover 214. Additional electronics, including any necessary antennas, transceivers, or other electronics may be housed beneath the cover 214. Additionally, the device 100 can include a sealing member or sealing ring 216 arranged about the ball chamber, configured to seal and/or seat within the bottle neck beneath the top 212.

C. Hub Device 700

The hub device consistent with embodiments of the present disclosure may be provided. The hub device may be embodied as at least a portion of a computing device 900 and/or the computing element.

In some embodiments, the hub device 700 may be configured to receive the sensor data from the device. In further embodiments, the hub device 700 may then be configured to calculate, for example, at least one of the following: an amount of liquid dispensed and an amount of liquid remaining in the bottle to which the device is attached. In some embodiments, the liquid dispensing container may be paired or registered with the hub device, along with a specification of a liquid container type that the device is configured to.

In further embodiments, the hub device 700 may be configured to receive a notification of the association of the liquid dispensing container and the liquid pouring device. In yet further embodiments, the hub device may be configured to receive a plurality of metrics associated with a liquid dispensing container connected to, and/or associated with, the liquid pouring device. In yet further embodiments, the hub device may be configured to receive volumetric data of the associated liquid dispensing container.

In still further embodiments, the hub device 700 may be configured to receive inventory data of the associated liquid dispensing container. In even further embodiments, the hub device 700 may be configured to receive the inventory data and/or volumetric data at a scheduled time. In some embodiments, receiving the inventory data may comprise calculating the inventory data at the hub device 700. In some embodiments, receiving the inventory data may comprise receiving the inventory data based on demand for additional product. In some embodiments determining the demand for additional product may be based on activity related to pouring liquid from one or more of the liquid pouring devices.

In yet still further embodiments, the hub device 700 may be configured to automatically re-order the same, similar, and/or related liquid dispensing containers based on the inventory data. In even still further embodiments, the hub device 700 may be configured to create and/or fill out a purchase order. In even yet still further embodiments, the hub device 700 may be configured to transmit the purchase order to a distributor, purveyor and/or manufacturer of liquid dispensing containers. In even yet still further embodiments, the hub may be configured to select the distributor based on an available inventory for filling the purchase order.

In even yet still further embodiments, the hub device 700 may be configured to determine, via acceptance or rejection of a user, whether to share the inventory data with third parties. In even yet still further embodiments, the hub device 700, responsive to determining that the user has agreed to share inventory data with third parties, is further configured to transmit a summary of the at least one purchase order to an authorized third party. In even yet still further embodiments, the hub device 700, responsive to determining that the user has agreed to share inventory data with third parties, is further configured to transmit live, real-time and/or a selected timeframe of inventory data to the authorized third party. In some embodiments, the authorized third-party may create a plurality of analytics to determine data such as consumption trends, preferred spirits, non-preferred spirits, preferred compliments to predetermined spirits. In some embodiments, the authorized third-party may be enabled to perform targeted marketing relating to the spirit consumption trends.

Byway of nonlimiting example, a tequila manufacturer and/or distributor may determine that a particular restaurant sells their tequila during particular timeframes on weekends; the tequila company then pushing targeted advertisements for margaritas during that timeframe to the restaurant consumer's mobile devices and/or the televisions located at the restaurant.

By further way of nonlimiting example, a scotch manufacturer and/or distributor may determine that a particular restaurant sells a higher-than-average amount of whiskey; the scotch company then pushing targeted advertisements and/or promotions for their scotch to the restaurant consumer's mobile devices and/or the televisions located at the restaurant.

By further way of nonlimiting example, a liquor manufacturer and/or distributor may push an advertisement to associated bars using the inventory tracking system and gain insight and/or analytics on the resulting sales of liquor, wine, and/or beer sold after the advertisement is shown.

D. Marketplace Module 800

A marketplace module 800 consistent with embodiments of the present disclosure may be provided. In some embodiments, the marketplace module 800 may be in operative and/or wireless communication with the hub device and/or at least one liquid pouring device.

In some embodiments, the marketplace module 800 may provide a centralized network for communication between buyers of spirits, liquor distributors, and data clients. In further embodiments, the marketplace module may facilitate a streamlined sales process for distributors to advertise, solicit, and sell their spirits to prospective buyers. By way of nonlimiting example, when an order of spirits is needed, the hub and/or user may request or publicly post in the marketplace module, and distributors may compete to bid and fill orders.

Distributors traditionally employ large salesforces to sell through their products. The marketplace reduces the work required to place and fulfill orders and may increase distributors' margins. In further embodiments, the marketplace module 800 may charge the distributor a set percentage fee on each order. In some embodiments, distributors may manage actual delivery of inventory to the physical location of the restaurant and/or bar.

### III. Platform Operation

Embodiments of the present disclosure provide a hardware and software system operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described to be performed by a single computing device, it should be understood that, in some embodiments, different operations may be performed by different networked elements in operative communication with the computing device. For example, at least one computing device 900 may be employed in the performance of some or all of the stages disclosed with regard to the methods. Similarly, an apparatus may be employed in the performance of some or all of the stages of the methods. As such, the system 600 may comprise at least those architectural components as found in computing device 900.

Furthermore, although the stages of the following example methods are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones claimed below. Moreover, various stages may be added or removed from the without altering or deterring from the fundamental scope of the depicted methods and systems disclosed herein.

A. Method 1000 for Auto Assignment of Liquid Pouring Devices Using Identifying Devices Connected to Liquid Dispensing Containers

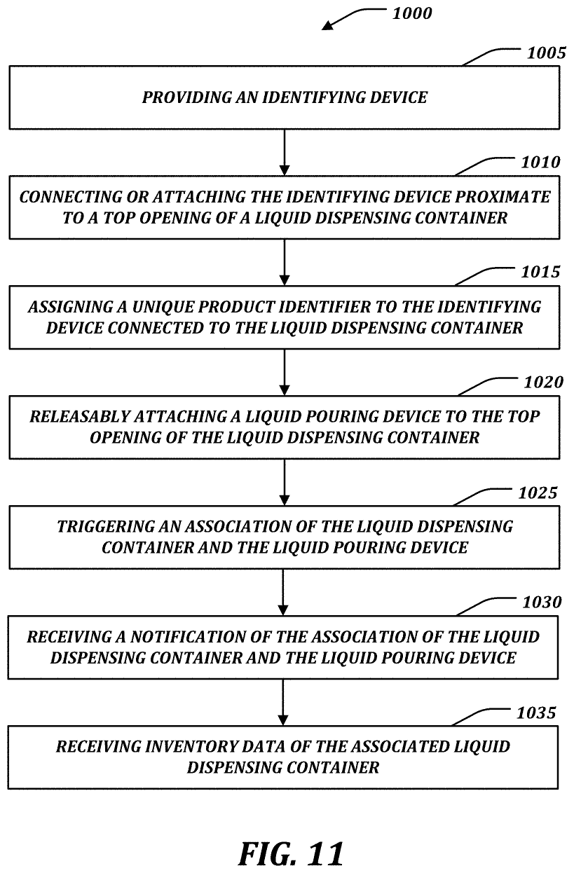

Consistent with embodiments of the present disclosure, a method 1000 may be performed by at least one of the aforementioned modules, illustrated at least in FIG. 11. In some embodiments, at least a portion of the method may be embodied as, for example, but not limited to, computer instructions, which when executed, perform the method.

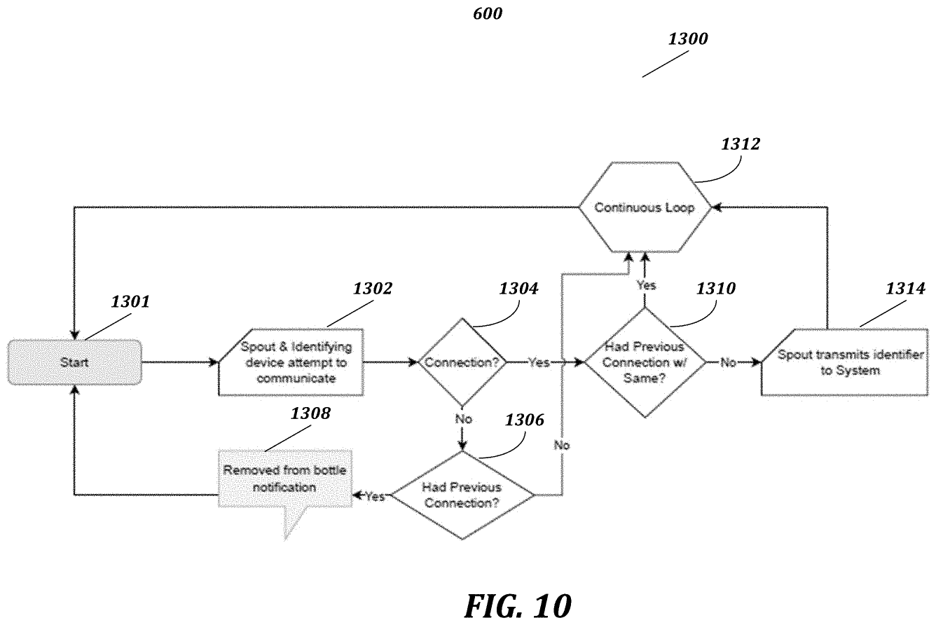

At least a portion of method 1000 may be illustrated in FIG. 10.

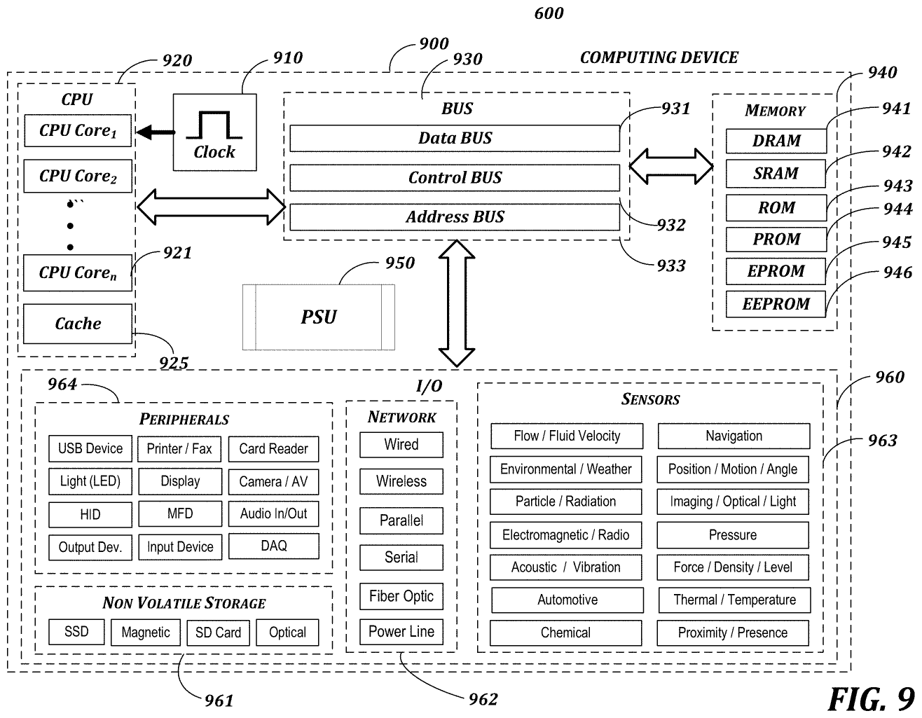

FIG. 11 is a flow chart setting forth the general stages involved in a method 1000 consistent with an embodiment of the disclosure for method for auto assignment of a plurality of transmitting devices. Method 1000 may be implemented using a computing device 900 or any other component associated with system 600 as described in more detail below with respect to FIG. 9. For illustrative purposes alone, computing device 900 is described as one potential actor in the following stages. In some embodiments, the following method may be performed and/or viewed from a hub device.

The method may comprise step 1005, providing an identifying device 151. By way of nonlimiting example, the identifying device 151 may comprise an electromagnetic communication component, such as a High Frequency (“HF”) and/or Ultra High Frequency (“UHF”) compatible device. In some embodiments, the device may be a dual-band, HF and UHF device, enabling two applications. A first application for a dual-band compatible device may comprise, for instance, tracking the liquid dispensing container as it relates to, for example, shipping, distribution, and storage application. A second application for a dual band device may comprise, for instance, associating a liquid pouring device with the liquid dispensing container. The electromagnetic components may comprise, but not be limited to, Near Field Communication (NFC), Radio Frequency Identification (RFID), Bluetooth, and/or other wireless technologies and protocols for transmitting the product identifier to the liquid pouring device.

The method may further comprise step 1010, connecting or attaching the identifying device 151 proximate to a top opening of a liquid dispensing container 175. In some embodiments, connecting the identifying device 151 may be via attaching or adhering the identifying device 151 on the neck 165 of the liquid dispensing container 175.

The method may further comprise step 1015, assigning a unique product identifier to the identifying device 151 connected to the liquid dispensing container 175. In some embodiments, the unique product identifier may comprise information such as, for example, but not limited to: type of liquor in the liquid dispensing container, a bottle-specific identifier (e.g., a unique bottle identification), brand of liquor in the liquid dispensing container, volume of liquid in the liquid dispensing container, time period of the liquid dispensing container since being bottled and/or sealed, price of the liquid dispensing container, and price per ounce of the liquid dispensing container.

The method may further comprise step 1020, releasably attaching a liquid pouring device 100, comprising a transceiver, receiver, and/or reader device 189, having a unique pouring device identifier, to the top opening of the liquid dispensing container 175. In some embodiments, releasably attaching the liquid pouring device 100 to the liquid dispensing container 175 may cause fluid communication between one another. In further embodiments, releasably attaching the liquid pouring device 100 to the liquid dispensing container 175 may allow liquid to be expelled from the liquid dispensing container 175 through the liquid pouring device 100.

The method may further comprise step 1025, triggering an association of the liquid dispensing container 175 and the liquid pouring device 100, upon the identifying device 151 and the corresponding transceiver component 189 of the liquid pouring device 100 being within a predetermined proximity of one another. In some embodiments, triggering an association of the liquid dispensing container 175 and the liquid pouring device 100 may comprise determining a need to collect data from the associated liquid dispensing container 175. In further embodiments, triggering an association of the liquid dispensing container 175 and the liquid pouring device 100 may comprise determining if the associated devices are within range of the hub device 700. In yet further embodiments, triggering an association of the liquid dispensing container 175 and the liquid pouring device 100 may comprise determining if a software update is available. Generally, the need to collect data may be based on a flow of business, a total number of pours from a device or other indicators of diminishing inventory. The need may also be based on a predetermined schedule, regular schedule, or other schedule. Software update availability may be manually pushed onto the hub or may be based on a predetermined schedule to check for updates.

The method may further comprise step 1030, receiving a notification of the association of the liquid dispensing container 175 and the liquid pouring device 100. In some embodiments, the method may further comprise receiving an indication of attaching the liquid pouring device 100 to the opening of the liquid dispensing container 175 via the liquid pouring device 100 being within a predetermined proximity to the identifying device 151. In further embodiments, the method may further comprise receiving an indication of removing the liquid pouring device 100 from the opening of the liquid dispensing container 175 via the liquid pouring device 100 leaving a predetermined proximity to the identifying device 151.

The method may further comprise step 1035, receiving inventory data of the associated liquid dispensing container 175. By way of nonlimiting example, the associated liquid dispensing container 175 may transmit volumetric data of the liquid dispensing container to the hub device 700. In some embodiments assembling and/or logging inventory data for the associated liquid dispensing container 175 and liquid pouring device 100 may occur responsive to the receiving of inventory data. In some embodiments, the assembled and/or logged inventory data may be viewed from a computing device connected to the hub device 700. In further embodiments, the assembled and/or logged inventory data may be viewed remotely from a computing device connected to an external network, cloud, cloud server, centralized server, and/or network in operative communication with the at least one liquid pouring device. In this embodiment, the at least one liquid pouring device 175 may be directly connected to the external network, cloud, cloud server, centralized server, and/or network in operative communication with the at least one liquid pouring device. In further embodiments, the assembling and/or logging can include aggregating data for a plurality of associated liquid dispensing container and liquid pouring device. In some embodiments, the assembled and/or logged inventory data may be transmitted to a centralized server or cloud server.

B. Method 1100 of Automated Inventory Control of Dispensed Liquids

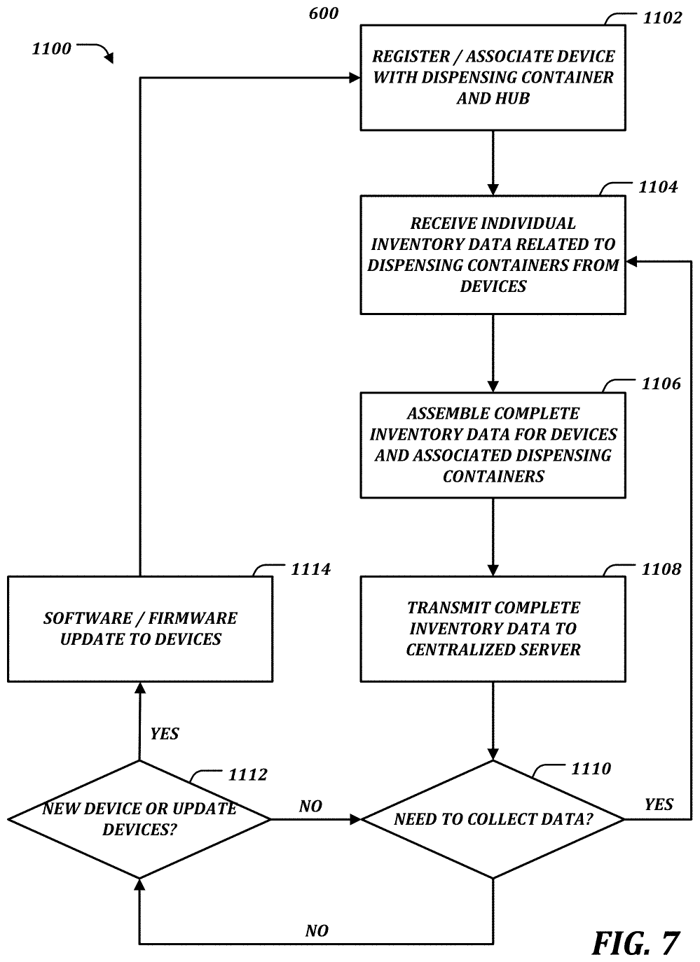

Consistent with embodiments of the present disclosure, a method 1100 may be performed by at least one of the aforementioned modules, illustrated at least in FIG. 7. At least a portion of the method 1100 may be embodied as, for example, but not limited to, computer instructions, which when executed, perform the method 1100.

The method 1100 may comprise step 1102, registering and/or associating the liquid pouring device 100 with the liquid dispensing container 175 and/or the hub 700.

The method 1100 may further comprise step 1104, receiving individual inventory data from a plurality of liquid pouring devices 100, each liquid pouring device of the plurality of liquid pouring devices being configured to receive and dispense a predetermined amount of liquid from the liquid dispensing container 175, and each of the plurality of liquid pouring devices 100 configured to transmit individual inventory data of the associated liquid dispensing container 175.

The method 1100 may further comprise step 1106, assembling inventory data for all liquid dispensing containers associated with a liquid pouring device, the inventory data including a volumetric measurement of predicted liquid retained in each liquid dispensing container.

The method 1100 may further comprise step 1108, transmitting complete inventory data to centralized server. The method may further comprise, from the view of the hub 700, receiving individual inventory data from inventory tracking devices that are active.

The method 1100 may further comprise step 1100, determining a need to update software on an existing registered device and/or register a new device on at least one inventory tracking device (and/or liquid pouring device 100). The method may further comprise determining that an unregistered inventory tracking device is within range of detection. The method 1100 may further comprise automatically registering individual liquid pouring devices to be associated with individual liquid dispensing containers upon being within a predetermined proximity of one another. An additional and/or alternate embodiment may comprise automatically registering individual liquid pouring devices to be associated with individual liquid dispensing containers upon a identifying device of the liquid pouring device being within a predetermined proximity of a transceiver, receiver, and/or reader device of the liquid dispensing container.

The method 1100 may further comprise wherein registering comprises assigning associated identifying data to a liquid pouring device, the identifying data identifying a particular type of liquid dispensing container associated with the liquid pouring device.

The method 1100 may further comprise step 1114, receiving the computer readable instructions (e.g., a software and/or firmware update) from a centralized server.

C. Method 1200 of Automated Inventory Control of Dispensed Liquids

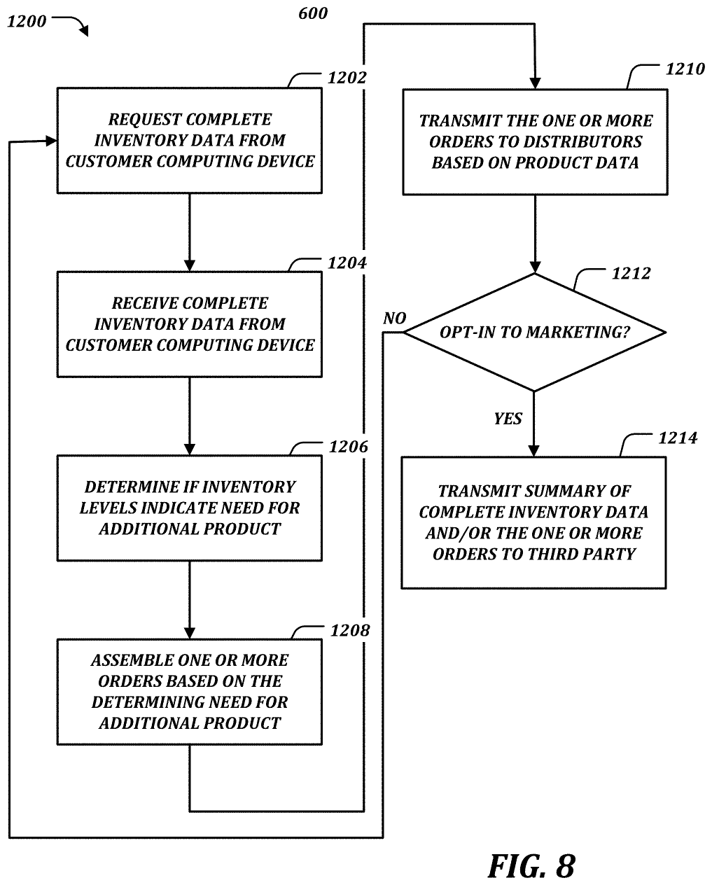

Consistent with embodiments of the present disclosure, a method 1200 may be performed by at least one of the aforementioned modules, illustrated at least in FIG. 8. At least a portion of the method 1200 may be embodied as, for example, but not limited to, computer instructions, which when executed, perform the method 1200.

The method 1200 may comprise step 1202, requesting complete inventory data from a customer computing device.

The method 1200 may comprise step 1204, receiving complete inventory data from the customer computing device.

The method 1200 may comprise step 1206, determining if inventory levels indicate need for additional product.

The method 1200 may comprise step 1208, assembling one or more orders based on the determining need for additional product.

The method 1200 may comprise step 1210, transmitting the one or more orders to distributors based on product data.

The method 1200 may comprise step 1212, opting in to marketing.

The method 1200 may comprise step 1214, transmitting summary of complete inventory data and/or the one or more orders to third party.

D. Method 1300 of Automated Inventory Control of Dispensed Liquids

Consistent with embodiments of the present disclosure, a method 1300 may be performed by at least one of the aforementioned modules, illustrated at least in FIG. 10. At least a portion of the method 1300 may be embodied as, for example, but not limited to, computer instructions, which when executed, perform the method 1300.

The method may start at step 1301.

The method 1300 may comprise step 1302, the spout (and/or identifying device) 100 attempting to communicate with one or more liquid dispensing containers 175.

The method 1300 may comprise step 1304, the spout 100 determining whether there is a connection with the one of the liquid dispensing containers 175.

The method 1300 may comprise step 1306, responsive to having an established connection, the spout 100 losing the connection with the one of the liquid dispensing containers 175 previously (and/or currently).

The method 1300 may comprise step 1308, responsive to having established the connection, receiving an indication of subsequently losing the established the connection, and/or connection transmitting a notification of said lost connection (e.g., removed from bottle notification).

The method 1300 may comprise step 1310, responsive to having an established connection, the spout 100, determining whether there was previously a connection with the one of the liquid dispensing containers 175.

The method 1300 may comprise step 1312, responsive to determining that there was previously a connection with the one of the liquid dispensing containers 175, reverting back to step 1301.

The method 1300 may comprise step 1314, responsive to determining that there was previously a connection with the one of the liquid dispensing containers 175, the spout 100 transmitting one or more identifiers to the hub 700 and/or a portion of the system 600.

### IV. Computing Device Architecture

Embodiments of the present disclosure provide a hardware and software platform operative as a distributed system of modules and computing elements.

At least a portion of system 600 may be embodied as, for example, but not be limited to, a website, a web application, a desktop application, backend application, and a mobile application compatible with a computing device 900. The computing device 900 may comprise, but not be limited to the following:

Mobile computing device, such as, but is not limited to, a laptop, a tablet, a smartphone, a drone, a wearable, an embedded device, a handheld device, an Arduino, an industrial device, or a remotely operable recording device;

A supercomputer, an exa-scale supercomputer, a mainframe, or a quantum computer;

A minicomputer, wherein the minicomputer computing device comprises, but is not limited to, an IBM AS400/iSeries/System I, A DEC VAX/PDP, a HP3000, a Honeywell-Bull DPS, a Texas Instruments TI-990, or a Wang Laboratories VS Series;

A microcomputer, wherein the microcomputer computing device comprises, but is not limited to, a server, wherein a server may be rack mounted, a workstation, an industrial device, a raspberry pi, a desktop, or an embedded device;

At least a portion of system 600 may be hosted on a centralized server or a cloud computing service. Although methods 1000-1300 have been described to be performed by a computing device 900, it should be understood that, in some embodiments, different operations may be performed by a plurality of the computing devices 900 in operative communication at least one network.

Embodiments of the present disclosure may comprise a system having a central processing unit (CPU) 920, a bus 930, a memory unit 940, a power supply unit (PSU) 950, and one or more Input/Output (I/O) units. The CPU 920 coupled to the memory unit 940 and the plurality of I/O units 960 via the bus 930, all of which are powered by the PSU 950. It should be understood that, in some embodiments, each disclosed unit may actually be a plurality of such units for the purposes of redundancy, high availability, and/or performance. The combination of the presently disclosed units is configured to perform the stages any method disclosed herein.

FIG. 9 is a block diagram of a system including computing device 900. Consistent with an embodiment of the disclosure, the aforementioned CPU 920, the bus 930, the memory unit 940, a PSU 950, and the plurality of I/O units 960 may be implemented in a computing device, such as computing device 900 of FIG. 9. Any suitable combination of hardware, software, or firmware may be used to implement the aforementioned units. For example, the CPU 920, the bus 930, and the memory unit 940 may be implemented with computing device 900 or any of other computing devices 900, in combination with computing device 900. The aforementioned system, device, and components are examples and other systems, devices, and components may comprise the aforementioned CPU 920, the bus 930, the memory unit 940, consistent with embodiments of the disclosure.

At least one computing device 900 may be embodied as any of the computing elements illustrated in all of the attached figures, including an inventory tracking system and/or platform, method for auto assignment of a plurality of liquid pouring device with liquid dispensing containers connected to identifying devices, and a method of automated inventory control of dispensed liquids. A computing device 900 does not need to be electronic, nor even have a CPU 920, nor bus 930, nor memory unit 940. The definition of the computing device 900 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 900, especially if the processing is purposeful.

With reference to FIG. 9, a system consistent with an embodiment of the disclosure may include a computing device, such as computing device 900. In a basic configuration, computing device 900 may include at least one clock module 910, at least one CPU 920, at least one bus 930, and at least one memory unit 940, at least one PSU 950, and at least one I/O 960 module, wherein I/O module may be comprised of, but not limited to a non-volatile storage sub-module 961, a communication sub-module 962, a sensors sub-module 963, and a peripherals sub-module 964.

A system consistent with an embodiment of the disclosure the computing device 900 may include the clock module 910 may be known to a person having ordinary skill in the art as a clock generator, which produces clock signals. Clock signal is a particular type of signal that oscillates between a high and a low state and is used like a metronome to coordinate actions of digital circuits. Most integrated circuits (ICs) of sufficient complexity use a clock signal in order to synchronize different parts of the circuit, cycling at a rate slower than the worst-case internal propagation delays. The preeminent example of the aforementioned integrated circuit is the CPU 920, the central component of modern computers, which relies on a clock. The only exceptions are asynchronous circuits such as asynchronous CPUs. The clock 910 can comprise a plurality of embodiments, such as, but not limited to, single-phase clock which transmits all clock signals on effectively 1 wire, two-phase clock which distributes clock signals on two wires, each with non-overlapping pulses, and four-phase clock which distributes clock signals on 4 wires.

Many computing devices 900 use a “clock multiplier” which multiplies a lower frequency external clock to the appropriate clock rate of the CPU 920. This allows the CPU 920 to operate at a much higher frequency than the rest of the computer, which affords performance gains in situations where the CPU 920 does not need to wait on an external factor (like memory 940 or input/output 960). Some embodiments of the clock 910 may include dynamic frequency change, where, the time between clock edges can vary widely from one edge to the next and back again.

A system consistent with an embodiment of the disclosure the computing device 900 may include the CPU unit 920 comprising at least one CPU Core 921. A plurality of CPU cores 921 may comprise identical CPU cores 921, such as, but not limited to, homogeneous multi-core systems. It is also possible for the plurality of CPU cores 921 to comprise different CPU cores 921, such as, but not limited to, heterogeneous multi-core systems, big.LITTLE systems and some AMD accelerated processing units (APU). The CPU unit 920 reads and executes program instructions which may be used across many application domains, for example, but not limited to, general purpose computing, embedded computing, network computing, digital signal processing (DSP), and graphics processing (GPU). The CPU unit 920 may run multiple instructions on separate CPU cores 921 at the same time. The CPU unit 920 may be integrated into at least one of a single integrated circuit die and multiple dies in a single chip package. The single integrated circuit die and multiple dies in a single chip package may contain a plurality of other aspects of the computing device 900, for example, but not limited to, the clock 910, the CPU 920, the bus 930, the memory 940, and I/O 960.

The CPU unit 920 may contain cache 922 such as, but not limited to, a level 1 cache, level 2 cache, level 3 cache or combination thereof. The aforementioned cache 922 may or may not be shared amongst a plurality of CPU cores 921. The cache 922 sharing comprises at least one of message passing and inter-core communication methods may be used for the at least one CPU Core 921 to communicate with the cache 922. The inter-core communication methods may comprise, but not limited to, bus, ring, two-dimensional mesh, and crossbar. The aforementioned CPU unit 920 may employ symmetric multiprocessing (SMP) design.

The plurality of the aforementioned CPU cores 921 may comprise soft microprocessor cores on a single field programmable gate array (FPGA), such as semiconductor intellectual property cores (IP Core). The plurality of CPU cores 921 architecture may be based on at least one of, but not limited to, Complex instruction set computing (CISC), Zero instruction set computing (ZISC), and Reduced instruction set computing (RISC). At least one of the performance-enhancing methods may be employed by the plurality of the CPU cores 921, for example, but not limited to Instruction-level parallelism (ILP) such as, but not limited to, superscalar pipelining, and Thread-level parallelism (TLP).

Consistent with the embodiments of the present disclosure, the aforementioned computing device 900 may employ a communication system that transfers data between components inside the aforementioned computing device 900, and/or the plurality of computing devices 900. The aforementioned communication system will be known to a person having ordinary skill in the art as a bus 930. The bus 930 may embody internal and/or external plurality of hardware and software components, for example, but not limited to a wire, optical fiber, communication protocols, and any physical arrangement that provides the same logical function as a parallel electrical bus. The bus 930 may comprise at least one of, but not limited to a parallel bus, wherein the parallel bus carry data words in parallel on multiple wires, and a serial bus, wherein the serial bus carry data in bit-serial form. The bus 930 may embody a plurality of topologies, for example, but not limited to, a multidrop/electrical parallel topology, a daisy chain topology, and a connected by switched hubs, such as USB bus. The bus 930 may comprise a plurality of embodiments, for example, but not limited to:
Internal data bus (data bus) 931/Memory bus
Control bus 932
Address bus 933
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as, but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but notlimited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 900 may employ hardware integrated circuits that store information for immediate use in the computing device 900, know to the person having ordinary skill in the art as primary storage or memory 940. The memory 940 operates at high speed, distinguishing it from the non-volatile storage sub-module 961, which may be referred to as secondary or tertiary storage, which provides slow-to-access information but offers higher capacities at lower cost. The contents contained in memory 940, may be transferred to secondary storage via techniques such as, but not limited to, virtual memory and swap. The memory 940 may be associated with addressable semiconductor memory, such as integrated circuits consisting of silicon-based transistors, used for example as primary storage but also other purposes in the computing device 900. The memory 940 may comprise a plurality of embodiments, such as, but not limited to volatile memory, non-volatile memory, and semi-volatile memory. It should be understood by a person having ordinary skill in the art that the ensuing are non-limiting examples of the aforementioned memory:
Volatile memory which requires power to maintain stored information, for example, but not limited to, Dynamic Random-Access Memory (DRAM) 941, Static Random-Access Memory (SRAM) 942, CPU Cache memory 925, Advanced Random-Access Memory (A-RAM), and other types of primary storage such as Random-Access Memory (RAM).
Non-volatile memory which can retain stored information even after power is removed, for example, but not limited to, Read-Only Memory (ROM) 943, Programmable ROM (PROM) 944, Erasable PROM (EPROM) 945, Electrically Erasable PROM (EEPROM) 946 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory which may have some limited non-volatile duration after power is removed but loses data after said duration has passed. Semi-volatile memory provides high performance, durability, and other valuable characteristics typically associated with volatile memory, while providing some benefits of true non-volatile memory. The semi-volatile memory may comprise volatile and non-volatile memory and/or volatile memory with battery to provide power after power is removed. The semi-volatile memory may comprise, but not limited to spin-transfer torque RAM (STT-RAM).

Consistent with the embodiments of the present disclosure, the aforementioned computing device 900 may employ the communication system between an information processing system, such as the computing device 900, and the outside world, for example, but not limited to, human, environment, and another computing device 900. The aforementioned communication system will be known to a person having ordinary skill in the art as I/O 960. The I/O module 960 regulates a plurality of inputs and outputs with regard to the computing device 900, wherein the inputs are a plurality of signals and data received by the computing device 900, and the outputs are the plurality of signals and data sent from the computing device 900. The I/O module 960 interfaces a plurality of hardware, such as, but not limited to, non-volatile storage 961, communication devices 962, sensors 963, and peripherals 964. The plurality of hardware is used by the at least one of, but not limited to, human, environment, and another computing device 900 to communicate with the present computing device 900. The I/O module 960 may comprise a plurality of forms, for example, but not limited to channel I/O, port mapped I/O, asynchronous I/O, and Direct Memory Access (DMA).

Consistent with the embodiments of the present disclosure, the aforementioned computing device 900 may employ the non-volatile storage sub-module 961, which may be referred to by a person having ordinary skill in the art as one of secondary storage, external memory, tertiary storage, off-line storage, and auxiliary storage. The non-volatile storage sub-module 961 may not be accessed directly by the CPU 920 without using intermediate area in the memory 940. The non-volatile storage sub-module 961 does not lose data when power is removed and may be two orders of magnitude less costly than storage used in memory module, at the expense of speed and latency. The non-volatile storage sub-module 961 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (961) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the aforementioned computing device 900 may employ the communication sub-module 962 as a subset of the I/O 960, which may be referred to by a person having ordinary skill in the art as at least one of, but not limited to, computer network, data network, and network. The network allows computing devices 900 to exchange data using connections, which may be known to a person having ordinary skill in the art as data links, between network nodes. The nodes comprise network computer devices 900 that originate, route, and terminate data. The nodes are identified by network addresses and can include a plurality of hosts consistent with the embodiments of a computing device 900. The aforementioned embodiments include, but not limited to personal computers, phones, servers, drones, and networking devices such as, but not limited to, hubs, switches, routers, modems, and firewalls.

Two nodes can be said are networked together, when one computing device 900 is able to exchange information with the other computing device 900, whether or not they have a direct connection with each other. The communication sub-module 962 supports a plurality of applications and services, such as, but not limited to World Wide Web (WWW), digital video and audio, shared use of application and storage computing devices 900, printers/scanners/fax machines, email/online chat/instant messaging, remote control, distributed computing, etc. The network may comprise a plurality of transmission mediums, such as, but not limited to conductive wire, fiber optics, and wireless. The network may comprise a plurality of communications protocols to organize network traffic, wherein application-specific communications protocols are layered, may be known to a person having ordinary skill in the art as carried as payload, over other more general communications protocols. The plurality of communications protocols may comprise, but not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], and Integrated Digital Enhanced Network [IDEN]).

The communication sub-module 962 may comprise a plurality of size, topology, traffic control mechanism and organizational intent. The communication sub-module 962 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMax and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus network such as ethernet, star network such as Wi-Fi, ring network, mesh network, fully connected network, and tree network. The network can be characterized by its physical capacity or its organizational purpose. Use of the network, including user authorization and access rights, differ accordingly. The characterization may include, but not limited to nanoscale network, Personal Area Network (PAN), Local Area Network (LAN), Home Area Network (HAN), Storage Area Network (SAN), Campus Area Network (CAN), backbone network, Metropolitan Area Network (MAN), Wide Area Network (WAN), enterprise private network, Virtual Private Network (VPN), and Global Area Network (GAN).

Consistent with the embodiments of the present disclosure, the aforementioned computing device 900 may employ the sensors sub-module 963 as a subset of the I/O 960. The sensors sub-module 963 comprises atleast one of the devices, modules, and subsystems whose purpose is to detect events or changes in its environment and send the information to the computing device 900. Sensors are sensitive to the measured property, are not sensitive to any property not measured, but may be encountered in its application, and do not significantly influence the measured property. The sensors sub-module 963 may comprise a plurality of digital devices and analog devices, wherein if an analog device is used, an Analog to Digital (A-to-D) converter must be employed to interface the said device with the computing device 900. The sensors may be subject to a plurality of deviations that limit sensor accuracy. The sensors sub-module 963 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensor (guitar pickup), seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, bedwetting alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, air speed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as, but not limited to, accelerometer, displacement sensor, flex sensor, free fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED as light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, Hall effect sensor, induction sensor, and wired glove.

Consistent with the embodiments of the present disclosure, the aforementioned computing device 900 may employ the peripherals sub-module 962 as a subset of the I/O 960. The peripheral sub-module 964 comprises ancillary devices uses to put information into and get information out of the computing device 900. There are 3 categories of devices comprising the peripheral sub-module 964, which exist based on their relationship with the computing device 900, input devices, output devices, and input/output devices. Input devices send at least one of data and instructions to the computing device 900. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to position of a mouse.
The number of degrees of freedom involved, such as, but not limited to, two-dimensional mice vs three-dimensional mice used for Computer-Aided Design (CAD) applications.

Output devices provide output from the computing device 900. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 964:
Input Devices
   Human Interface Devices (HID), such as, but not limited to, pointing device (e.g., mouse, touchpad, joystick, touchscreen, game controller/gamepad, remote, light pen, light gun, Wii remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 900. The information can be stored in a multitude of formats depending on the user's requirement. Examples of types of video input devices include, but not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device, in order to capture produced sound. Audio input devices allow a user to send audio signals to the computing device 900 for at least one of processing, recording, and carrying out commands. Devices such as microphones allow users to speak to the computer in order to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 900. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices, which convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers and plotters.
   Audio and Video (AV) devices, such as, but not limited to, speakers, headphones, amplifiers and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking device (e.g., devices disclosed in network 962 sub-module), data storage device (non-volatile storage 961), facsimile (FAX), and graphics/sound cards.

All rights including copyrights in the code included herein are vested in and the property of the Applicant. The Applicant retains and reserves all rights in the code included herein, and grants permission to reproduce the material only in connection with reproduction of the granted patent and for no other purpose.

### V. Aspects

The following disclose various Aspects of the present disclosure. The various Aspects are not to be construed as patent claims unless the language of the Aspect appears as a patent claim. The Aspects describe various non-limiting embodiments of the present disclosure.

Aspect 1. A method or system for automatic assignment of liquid pouring devices to liquid dispensing containers with connected identifying devices, the method or system comprising:

affixing an identifying device, to a liquid dispensing container;

releasably attaching a liquid pouring device to an opening of the liquid dispensing container;

pairing the liquid dispensing container and the liquid pouring device upon the identifying device and the liquid pouring device being within a predetermined proximity of one another;

associating data collected from the liquid pouring device with the liquid dispensing container; and

receiving inventory data of the associated liquid dispensing container.

Aspect 2. The method or system of any preceding claim, further comprising receiving an acceptance or a rejection of the promotion from the third-party.
Aspect 3. The method or system of any preceding claim, wherein the inventory data is from a predetermined period associated with a marketing campaign or promotion.
Aspect 4. The method or system of any preceding claim, further comprising analyzing inventory data to determine pour trends and/or consumption analytics.
Aspect 5. The method or system of any preceding claim, further comprising offering a promotion to the third-party based on the inventory data analysis.
Aspect 6. The method or system of any preceding claim, further comprising determining a need to update software on at least one liquid pouring device.
Aspect 7. The method or system of any preceding claim, wherein the predetermined proximity comprises a predetermined minimum time within the predetermined proximity.
Aspect 8. The method or system of any preceding claim, wherein the predetermined proximity comprises a predetermined geometry and/or predetermined orientation between the liquid pouring device and identifying device.
Aspect 9. The method or system of any preceding claim, further comprising receiving the computer readable instructions from a centralized server.
Aspect 10. The method or system of any preceding claim, wherein the readable medium comprises a barcode, QR code, or other like means of representing data in a visual, machine-readable form.
Aspect 11. The method or system of any preceding claim, wherein the predetermined orientation comprises a parallel orientation.
Aspect 12. The method or system of any preceding claim, wherein the predetermined orientation comprises a parallel orientation, and wherein the identifying device is placed on a neck of the liquid dispensing container.
Aspect 13. The method or system of any preceding claim, further comprising receiving individual inventory data from inventory tracking devices that are active.
Aspect 14. The method or system of any preceding claim, wherein each liquid pouring device is configured to receive and dispense a predetermined amount of liquid from a liquid dispensing container, and each liquid pouring device is configured to transmit individual inventory data of the associated liquid dispensing container.
Aspect 15. The method or system of any preceding claim, wherein each liquid pouring device is configured to track inventory associated with the liquid dispensing container.
Aspect 16. The method or system of any preceding claim, wherein the unique product identifier comprises identifying data or product identifying information.
Aspect 17. The method or system of any preceding claim, wherein the unique product identifier comprises identifying data related to the liquid dispensing container or product identifying information related to the liquid dispensing container.
Aspect 18. The method or system of any preceding claim, wherein the unique product identifier comprises identifying data or identifying information corresponding to the composition and/or quantity contents of the liquid dispensing container.
Aspect 19. The method or system of any preceding claim, wherein the liquid pouring device comprises a transceiver device and/or receiver configured to receive the unique product identifier from the identifying device upon being within a predetermined proximity of one another.
Aspect 20. The method or system of any preceding claim, further comprising providing the unique product identifier to the liquid pouring device using a readable medium.
Aspect 21. The method or system of any preceding claim, wherein each liquid pouring device is configured to determine that inventory levels from the inventory data indicate a need for additional product.
Aspect 22. The method or system of any preceding claim, wherein the liquid pouring device comprises a sensor stick with sensors configured to obtain or read the unique product identifier from the identifying device upon being within a predetermined proximity of one another.
Aspect 23. The system or method of any preceding claim, wherein the liquid pouring device is configured to perform the following: receive a notification of association between the liquid dispensing container and the liquid pouring device; and receive inventory data of the associated liquid dispensing container.
Aspect 24. The method or system of any preceding claim, wherein the identifying device is disposed around a circumference of the top opening effective to align or substantially align the neck of the bottle; wherein the predetermined orientation of a field is down from the top opening.
Aspect 25. The method or system of any preceding claim, further comprising transmitting inventory data to a third party.

### VI. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A method for automatic detection of liquid dispensed from a liquid pouring device, the method comprising:
affixing an identifying device, to a liquid dispensing container, the identifying device being associated with the liquid dispensing container;
attaching a liquid pouring device to an opening of the liquid dispensing container;
identifying the liquid dispensing container responsive to the liquid pouring device being within a predetermined proximity to the identifying device; and
associating data collected from the liquid pouring device with the liquid dispensing container.

2. The method of claim 1, further comprising:
assigning a unique product identifier to the identifying device, and
configuring the identifying device to provide the unique product identifier to the liquid pouring device responsive to the identifying device being within the predetermined proximity of the liquid pouring device.

3. The method of claim 1, further comprising assigning a liquid pouring device identifier to the liquid pouring device.

4. The method of claim 1, further comprising:
receiving a notification of association between the liquid dispensing container and the liquid pouring device, and
receiving inventory data of the associated liquid dispensing container.

5. The method of claim 1, further comprising receiving a notification responsive to one or more of the following:
an indication of attaching the liquid pouring device to the opening of the liquid dispensing container via the liquid pouring device being within a predetermined proximity to the identifying device, and
an indication of removing the liquid pouring device from the opening of the liquid dispensing container via the liquid pouring device leaving a predetermined proximity to the identifying device.

6. The method of claim 1, wherein the identifying device is proximate to an opening of the liquid dispensing container.

7. The method of claim 1, wherein the identifying device comprises at least one of the following:
an RFID device;
a near field communication (NFC) device, and
a Bluetooth device.

8. An inventory tracking system, the system comprising:
an identifying device comprising a product identifier, the identifying device configured to be connected proximate to an opening of a liquid dispensing container; and
a liquid pouring device comprising a unique pouring device identifier, the liquid pouring device configured to be secured to a top opening of a liquid dispensing container for dispensing liquid from therein;
wherein upon being within a predetermined proximity of one another, the identifying device and liquid pouring device are configured to cooperate to trigger an association between the liquid dispensing container and the liquid pouring device.

9. The system of claim 8, further comprising a hub device configured to perform the following:
receive a notification of association between the liquid dispensing container and the liquid pouring device; and
receive inventory data of the associated liquid dispensing container.

10. The system of claim 8, wherein the hub device is further configured to perform the following:
reorder product when a liquid dispensing container supply goes below a predetermined threshold; and
transmit inventory data to at least one third-party upon granted permission from an authorized user.

11. A method of automated inventory control of dispensed liquids, the method comprising:
registering individual liquid pouring devices from a plurality of liquid pouring devices to individual liquid dispensing containers from a plurality of liquid dispensing containers, each liquid dispensing container comprising an identifying device, upon an individual liquid pouring device being within a predetermined proximity of a connected identifying device effective to trigger an association between the individual liquid pouring devices to the individual liquid dispensing container connected to said identifying device;
receiving individual inventory data from each of the plurality of liquid pouring devices, each liquid pouring device of the plurality of liquid pouring devices being configured to receive and dispense a predetermined amount of liquid from each of the plurality of liquid dispensing containers, each of the plurality of liquid pouring devices being configured to transmit individual inventory data of the associated liquid dispensing container; and
assembling inventory data for the plurality of liquid dispensing containers associated with the plurality of liquid pouring devices, the inventory data comprising a volumetric measurement of predicted liquid retained in each of the plurality of liquid dispensing containers.

12. The method of claim 11, further comprising configuring a transmitting device disposed on the identifying device to transmit a unique product identifier to the liquid pouring device upon being within a predetermined proximity of one another.

13. The method of claim 11, wherein the transmitting device comprises one or more of the following:
Near Field Communication (NFC),
Radio Frequency Identification (RFID), and
Bluetooth.

14. The method of claim 11, wherein the liquid pouring device is configured to obtain the unique product identifier from the identifying device upon being within a predetermined proximity of one another.

15. The method of claim 11, wherein the liquid pouring device comprises a sensor cavity with a sensor stick and a transceiver configured to obtain the unique product identifier from the identifying device responsive to being inserted into the neck of the liquid dispensing container.

16. The method of claim 11, wherein the unique product identifier comprises identifying data or product identifying information corresponding to one or more of the following:
a product universal product code (UPC),
a product stock keeping unit (SKU),
a product brand,
a product container size,
a product type,
a product content,
a product volume,
a product weight,
a product production date,
a product expiration date,
a product attribute, and
a product property.

17. The method of claim 11, wherein the identifying device comprises one or more of a label, a tag, and a sticker, the identifying device being configured to be attached to a surface proximate to the top opening.

18. The method of claim 11, wherein associating or registering comprises assigning associated identifying data to a liquid pouring device, the identifying data identifying a particular type of liquid dispensing container associated with the liquid pouring device.

19. The method of claim 11, further comprising determining that an unregistered liquid pouring device is within range of detection.

20. The method of claim 11, wherein the inventory data comprises pour volume and/or pour rate.
